(19) United States
(12) Patent Application Publication
(10) Pub. No.: US 2024/0247535 A1
(43) Pub. Date: Jul. 25, 2024

(54) ATTACHABLE BLIND BRACKET FOR WINDOW

(71) Applicant: HAWKES DESIGN AND CONSULTING, LLC, Charleston, SC (US)

(72) Inventor: Henry M. Hay, III, CHARLESTON, SC (US)

(21) Appl. No.: 18/626,457

(22) Filed: Apr. 4, 2024

Related U.S. Application Data
(63) Continuation-in-part of application No. 18/109,652, filed on Feb. 14, 2023.
Application No. 18/109,652 is a continuation-in-part of application No. 17/964,577, filed on Oct. 12, 2022.
Application No. 17/964,577 is a continuation-in-part of application No. 17/109,766, filed on Dec. 2, 2020, now Pat. No. 11,499,362.
(60) Provisional application No. 63/044,576, filed on Jun. 26, 2020.

(51) Int. Cl. E06B 1/36; A47H 1/18

(52) U.S. Cl. CPC E06B 1/36; A47H 1/18

(57) ABSTRACT

Various window jamb and window jamb assemblies are provided. An example window jamb assembly includes a window jamb with a recess along a lineal profile of the window jamb. At least one protrusion is defined within the recess. The window jamb assembly includes an insertable attachment component including a screw boss. The insertable attachment component is structured to engage with the at least one protrusion defined within the recess. The insertable attachment component is structured to receive a screw via the screw boss.

### TECHNOLOGICAL FIELD

This disclosure relates generally to a window and door framing system and method, and in particular to a window frame design that allows for a bracket to be attached.

### BACKGROUND

Blinds are often positioned adjacent to a window in order to block unwanted light from entering the inside area. Traditionally, blinds are either outside mount or inside mount, such that the blinds are mounted either outside the outer edges of a window or between the frame of the window. Outside mounted blind brackets are traditionally installed above the window directly into a wall (e.g., into a stud in the wall). However, this causes damage to the wall surrounding the window, as well as takes unnecessary space around the window. Thus, there is a long sought need to provide windows that provide for unitary blind installation.

### BRIEF SUMMARY

The following paragraphs present a summary of various embodiments of the present disclosure and are merely examples of potential embodiments. As such, the summary is not meant to limit the subject matter or variations of various embodiments discussed herein.

In some aspects, the techniques described herein relate to a window jamb assembly, including: a window jamb with a recess along a lineal profile of the window jamb, wherein at least one protrusion is defined within the recess; and an insertable attachment component including a screw boss, wherein the insertable attachment component is structured to engage with the at least one protrusion defined within the recess, wherein the insertable attachment component is structured to receive a screw via the screw boss.

In some aspects, the techniques described herein relate to a window jamb assembly, further including a blind bracket, wherein the blind bracket defines at least one screw aperture that allows the screw to pass through and engaged the screw boss of the insertable attachment component.

In some aspects, the techniques described herein relate to a window jamb assembly, wherein the blind bracket defines an attachment side, wherein the attachment side includes the at least one screw aperture and at least one protruding dimple.

In some aspects, the techniques described herein relate to a window jamb assembly, wherein the window jamb includes an inward dimple structured to receive the at least one protruding dimple.

In some aspects, the techniques described herein relate to a window jamb assembly, wherein the blind bracket defines an attachment side and an extending side, wherein the extending side is perpendicular to the attachment side.

In some aspects, the techniques described herein relate to a window jamb assembly, wherein at least one of the attachment side or the extending side define a tab that is structured to engage a blind.

In some aspects, the techniques described herein relate to a window jamb assembly, further including an additional insertable attachment component including an additional screw boss, wherein the additional insertable attachment component is structured to engage with the at least one protrusion defined within the recess.

In some aspects, the techniques described herein relate to a window jamb assembly, wherein the insertable attachment component is inserted proximate a first end of the window jamb and the additional insertable attachment component is inserted proximate a second end of the window jamb.

In some aspects, the techniques described herein relate to a window jamb assembly, wherein a distance between the insertable attachment component and the additional insertable attachment component is based on a size of a window.

In some aspects, the techniques described herein relate to a window jamb assembly, wherein the insertable attachment component defines at least one cantilever portion structured to engage at least one of the at least one protrusion defined within the recess.

In some aspects, the techniques described herein relate to a window jamb assembly, wherein the at least one cantilever portion includes a tapered hook to engage at least one of the at least one protrusion defined within the recess.

In some aspects, the techniques described herein relate to a window jamb assembly, wherein the insertable attachment component includes a U-shape with a first side, a second side, and a third side, wherein the first side of the insertable attachment component is engageable with one of the at least one protrusion.

In some aspects, the techniques described herein relate to a window jamb assembly, wherein the window jamb defines a first end and a second end, wherein the first end of the window jamb includes an aperture to receive a screw.

In some aspects, the techniques described herein relate to a method for manufacturing a window jamb assembly, the method including: providing a window jamb with a recess along a lineal profile of the window jamb, wherein at least one protrusion is defined within the recess; and providing an insertable attachment component including a screw boss, wherein the insertable attachment component is structured to engage with the at least one protrusion defined within the recess, wherein the insertable attachment component is structured to receive a screw via the screw boss.

In some aspects, the techniques described herein relate to a method, further including providing a blind bracket, wherein the blind bracket defines at least one screw aperture that allows the screw to pass through and engaged the screw boss of the insertable attachment component.

In some aspects, the techniques described herein relate to a method, wherein the blind bracket defines an attachment side, wherein the attachment side includes the at least one screw aperture and at least one protruding dimple.

In some aspects, the techniques described herein relate to a method, wherein the blind bracket defines an attachment side and an extending side, wherein the extending side is perpendicular to the attachment side, wherein at least one of the attachment side or the extending side define a tab that is structured to engage a blind.

In some aspects, the techniques described herein relate to a method, wherein the insertable attachment component defines at least one cantilever portion structured to engage at least one of the at least one protrusion defined within the recess.

In some aspects, the techniques described herein relate to a method, wherein the at least one cantilever portion includes a tapered hook to engage at least one of the at least one protrusion defined within the recess.

In some aspects, the techniques described herein relate to a method, wherein the insertable attachment component includes a U-shape with a first side, a second side, and a third side, wherein the first side of the insertable attachment component is engageable with one of the at least one protrusion.

These and other advantages will be apparent to those skilled in the art of window design and installation particularly for buildings in areas where security or severe weather is a concern.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings

FIGS. 1A-1C illustrate various cross-sections of example embodiments of an extruded lineal for a window, in accordance with various embodiments of the present disclosure;

FIGS. 2A-2D illustrate example insertable attachment components coupled to a window jamb, in accordance with various embodiments of the present disclosure;

FIGS. 3A-3C illustrate the insertable attachment components shown in FIGS. 2A-2C, in accordance with various embodiments of the present disclosure;

FIG. 4 illustrates an example insertable attachment component positioned within a recess of a window jamb, in accordance with various embodiments of the present disclosure;

FIGS. 5A and 5B illustrate multiple views of a blind bracket used in accordance with various embodiments of the present disclosure;

FIG. 5C illustrates another example blind bracket used in accordance with various embodiments of the present disclosure;

FIG. 6 illustrates apertures defined on a window jamb in various embodiments of the present disclosure;

FIG. 7A illustrates another example aperture in a window jamb in accordance with various embodiments of the present disclosure;

FIG. 7B illustrate an example blind bracket used for engaging the window jamb of FIG. 7A in accordance with various embodiments of the present disclosure;

FIGS. 8A and 8B illustrate example blind brackets attached to the window jamb via a screw boss in accordance with various embodiments of the present disclosure; and

FIG. 9 illustrates another window jamb configuration with multiple screw bosses in accordance with various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

The term “astragal” refers to hardware that is used on a pair of doors to seal the gap between the doors when they are closed. The astragal is fastened to the doors themselves on the sides of the doors that meet, rather than to a separate door frame.

The term “building” will be used here for convenience to mean any structure with openings in its walls. The structure includes by way of example, and not of limitation, homes, apartment buildings, and commercial buildings. The word “walls” refers to barriers such as walls, ceilings, and floors, that are positioned between the inside of the building and its outside.

The term “customizable” is used herein to describe the ability to choose from a selection of options among protective mechanisms that protect the interior of a building from physical damage as a result of severe weather or a security threat outside the building. The features selected from among the options are added to an extruded, pultruded, or co-extruded frame of a that was manufactured with specific elements. These protective mechanisms improve the ability of the window or door to withstand increased stress from a security threat, high winds, heavy rain, hurricanes, and flying debris or hail.

The term “door” will be used to indicate an entry and egress point in a building, and shall include framing along with the ability to cover the door with the disclosure herein.

The term “extruded” is used herein for convenience but jambs, sills and headers may be formed in any way customary in the industry, for example, pultruded, and co-extruded with other materials.

The term “frame” as used herein, and used in connection with a window or door, such as a “window frame” an “opening frame” or a “door frame,” refers to the structure that is attached to a building where a hole has been made in the building for receiving a window or door (or receiving a vent or an appliance such as a wall-mounted air conditioner). The frame is typically a four-sided structure that is sealed to the opening made for it and that holds the window, door, vent, or appliance. In various embodiments, the term “frame” and the term “jamb” may be used interchangeably unless otherwise indicated.

The term “jamb” may refer to any of the individual sections of a frame. For example, the frame may include a first jamb, a second jamb, a header, and a sill. Each of the first jamb, a second jamb, a header, and a sill may be referred to as a “jamb” or “window jamb.”

The term “window” will be used to refer to an opening in a wall, as defined herein, such as a window in a wall, a window in a door, a skylight in a ceiling, or a sliding glass door in a wall, where the window has a covering that admits light, unlike the opaque material of the wall, door frame, and roof.

The term “screw boss” is a physical structure that grips the threads of a screw being driven into it so that, once the screw has been inserted into or through the screw boss, the screw boss resists the removal of the screw more when the screw is pulled than when the screw is unscrewed. This installation further provides support for attachments such as high wind panels, blinds, and other attachments, allowing for additional weight support in the frame. While the various screw bosses discussed herein are referred to in the singular, a screw boss shown in a lineal profile of a window jamb may represent multiple screw bosses defined along the window jamb. For example, a screw boss may be provided at each location along a window jamb in which an aperture (the lower aperture(s) 605 and/or the lower aperture(s) 610 shown in FIG. 6) is defined.

An “insertable screw boss” is a screw boss that has been separately extruded so that it can be inserted into a channel and is otherwise functionally the same as a screw boss extruded as an integral part of that channel, but allowing for further customization depending upon the time of fastener. This installation further provides support for attachments such as high wind panels, blinds, and other attachments, allowing for additional weight support in the frame.

The term “window treatment” means a cover or modification of a window, with an aim of enhancing the aesthetics of the window. For purposes of this definition a window may also appear on a door. Further, a window treatment encompasses hard treatments such as wood, vinyl, aluminum, and window blinds, shades, and drapery fixtures. Additionally, the term “blind” may include various other types of window treatments discussed herein.

### I. Example Use Case

In some aspects, the techniques described herein relate to a window jamb assembly, including: a window jamb with a recess along a lineal profile of the window jamb, wherein at least one protrusion is defined within the recess; and an insertable attachment component including a screw boss, wherein the insertable attachment component is structured to engage with the at least one protrusion defined within the recess, wherein the insertable attachment component is structured to receive a screw via the screw boss.

In some aspects, the techniques described herein relate to a window jamb assembly, further including a blind bracket, wherein the blind bracket defines at least one screw aperture that allows the screw to pass through and engaged the screw boss of the insertable attachment component.

In some aspects, the techniques described herein relate to a window jamb assembly, wherein the blind bracket defines an attachment side, wherein the attachment side includes the at least one screw aperture and at least one protruding dimple.

In some aspects, the techniques described herein relate to a window jamb assembly, wherein the window jamb includes an inward dimple structured to receive the at least one protruding dimple.

In some aspects, the techniques described herein relate to a window jamb assembly, wherein the blind bracket defines an attachment side and an extending side, wherein the extending side is perpendicular to the attachment side.

In some aspects, the techniques described herein relate to a window jamb assembly, wherein at least one of the attachment side or the extending side define a tab that is structured to engage a blind.

In some aspects, the techniques described herein relate to a window jamb assembly, further including an additional insertable attachment component including an additional screw boss, wherein the additional insertable attachment component is structured to engage with the at least one protrusion defined within the recess.

In some aspects, the techniques described herein relate to a window jamb assembly, wherein the insertable attachment component is inserted proximate a first end of the window jamb and the additional insertable attachment component is inserted proximate a second end of the window jamb.

In some aspects, the techniques described herein relate to a window jamb assembly, wherein a distance between the insertable attachment component and the additional insertable attachment component is based on a size of a window.

In some aspects, the techniques described herein relate to a window jamb assembly, wherein the insertable attachment component defines at least one cantilever portion structured to engage at least one of the at least one protrusion defined within the recess.

In some aspects, the techniques described herein relate to a window jamb assembly, wherein the at least one cantilever portion includes a tapered hook to engage at least one of the at least one protrusion defined within the recess.

In some aspects, the techniques described herein relate to a window jamb assembly, wherein the insertable attachment component includes a U-shape with a first side, a second side, and a third side, wherein the first side of the insertable attachment component is engageable with one of the at least one protrusion.

In some aspects, the techniques described herein relate to a window jamb assembly, wherein the window jamb defines a first end and a second end, wherein the first end of the window jamb includes an aperture to receive a screw.

In some aspects, the techniques described herein relate to a method for manufacturing a window jamb assembly.

### II. Systems and Methods

Blinds are often positioned on the interior of a window in order to block unwanted light from the inside area. Traditionally, blinds are either outside mount or inside mount, such that the blinds are mounted either outside the outer edges of a window or between the frame of the window. Outside mounted blind brackets are traditionally required to be installed above the window directly into a wall (e.g., into a stud of the wall). However, this causes damage to the wall surrounding the window, as well as takes unnecessary space around the window. Thus, there is a long sought need to provide window that provides for unitary blind installation.

In various embodiments of the present disclosure, window jamb(s) are provided for use in a window. The window jamb(s) include a recess defined within the lineal profile of the window jamb. At least one protrusion may be defined within the recess. For example, the recess may define a first protrusion and a second protrusion. An insertable attachment component may be structured to be coupled to the window jamb via the recess. Various different embodiments of the insertable attachment components may include at least one cantilever portion with a tapered hook structured to engage at least one of the protrusions. Using various embodiments discussed herein, the window jamb may be structured to allow a cover panel (e.g., a storm cover) and a blind to also be attached to the window frame.

A blind bracket may be attached to the window jamb via attaching the blind bracket to the window jamb via at least one screw attached to the insertable attachment component. The blind bracket may define screw apertures that allow for a screw or other fastener to attach the blind bracket to the window jamb. The blind bracket may include one or more protruding dimples to engage with the window jamb. The blind bracket may be structured to receive a blind and fix the blind to the window jamb.

### III. With Reference to the Figures

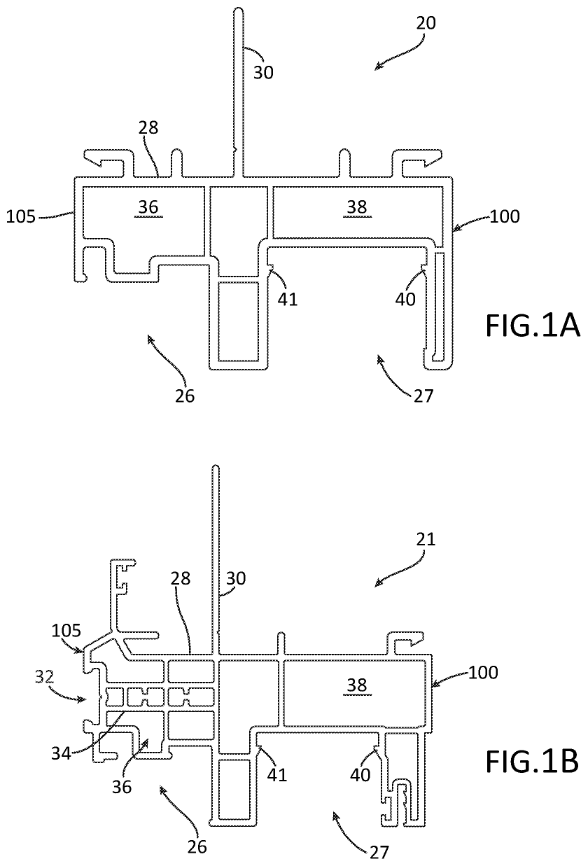

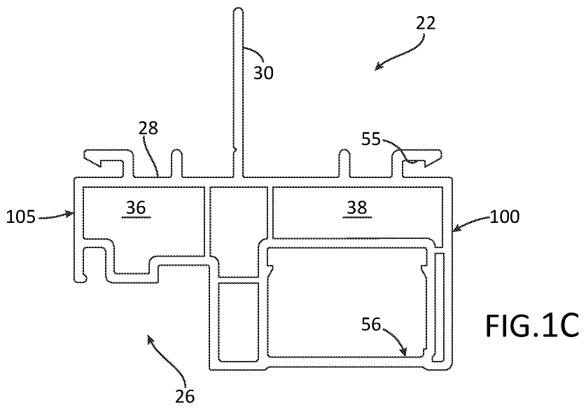

Referring now to FIGS. 1A and 1B, an end view of example lineal profiles (e.g., lineal profile of the window jamb 20 of FIG. 1A and lineal profile 21 of the window jamb 21 of FIG. 1B) used in a window frame are shown. The first window jamb 20 of FIG. 1A and the second window jamb 21 of FIG. 1B are merely example window jambs used in various embodiments of the present disclosure. As such, various lineal profile designs may include the features discussed herein. As discussed above, the window jamb may include any section of the frame (e.g., jambs, sill, header, etc.).

In various embodiments, the window jamb may be used in window. The window may include a first jamb, a second jamb, a header, and a sill (collectively “window jambs”). Any of the first jamb, the second jamb, the header, and/or the sill may be a window jamb of various embodiments. Each of the window jambs may include a glazing recess to receive a glazing (e.g. glass for a window). The window may include a storm track on the exterior of the window to receive a covering.

The window jambs of various embodiments, such as the window jambs shown in FIGS. 1A and 1B may be long, rigid, co-co-extruded article of manufacture that are to be cut into sections. The sections have a specified length and can be assembled (usually the frame has four sections including two jambs, a sill, and a header) into a rectangle that defines a (rectangular) window frame. The lineal profiles shown in FIGS. 1A and 1B contain representative internal features common to many window frames. The features of window jamb (e.g., the first window jamb 20 of FIG. 1A and/or the second window jamb 21 of FIG. 1B) have specific functions and some are decorative, namely those on the first end 100 and second end 105 of FIGS. 1A and 1B which will become the interior and exterior ends, respectively, of a window frame. The second end 105 (shown in FIGS. 1A and 1B) is the exterior-facing configuration of the frame, and the first end 100 (shown in FIGS. 1A and 1B) is the interior-facing side of the frame.

Referring now to lineal profile of the first window jamb 20 of FIG. 1A, the first window jamb 20 is shown. Unless otherwise stated, the second window jamb 21 of FIG. 1B includes each of the features of the first window jamb 20. In various embodiments, the first window jamb 20 includes a first end 100 and a second end 105. The first end 100 of the first window jamb 20 is structured to be positioned as the inside of the window and the second end 105 of the first window jamb 20 is structured to be positioned as the exterior of the window. For example, for an exterior facing window, the first end 100 of the first window jamb 20 is positioned adjacent to the inside of the given structure and the second end 105 of the first window jamb 20 positioned adjacent the outside of the given structure. As such, the first end 100 of the first window jamb 20 may be positioned on an interior of a structure, such that a blind and/or curtain may be positioned adjacent to selectively cover the window. In various embodiments, the first window jamb 20 may be structured such that the blinds may be attached at the first end 100. The second window jamb 21 of FIG. 1B also includes a first end 100 and a second end 105 that are also structured to be the interior end (the first end 100) and the exterior end (the second end 105).

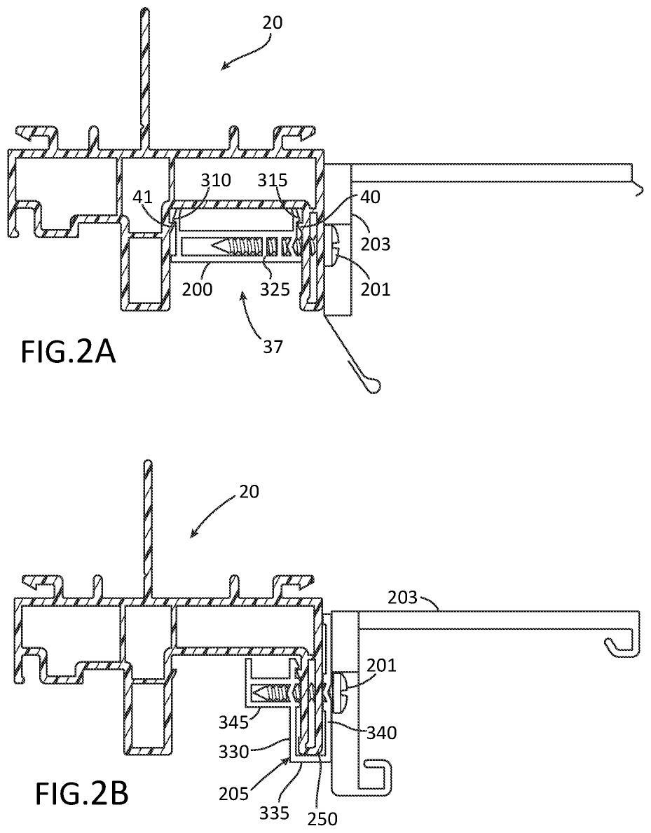

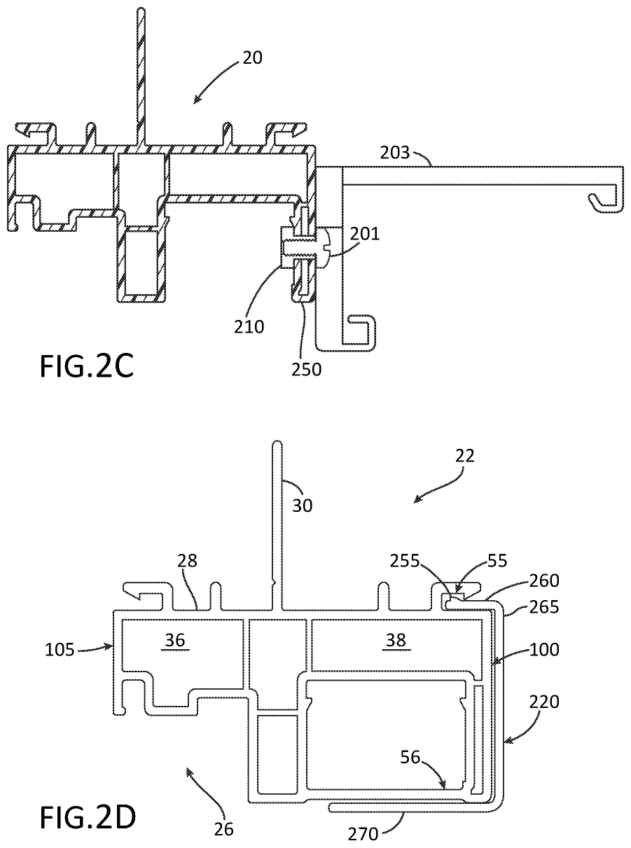

As shown in FIGS. 1A and 1B, the window jambs are structured to receive one or more windows (e.g., one or more glazed windows) which will fit into recess 26 and/or recess 27. As discussed herein, the recess 27 may additionally or alternatively be used to receive an insertable attachment component for a blind to be installed, as shown in FIGS. 2A-2D. The wall attachment side 28 of FIGS. 1A and 1B are the part of given widow jamb that is to be attached to the wall of the building. A nail fin 30 extending from the wall attachment side 28 permits the frame of a window to be attached to the framing of the building at the opening for the window.

As discussed in reference to FIGS. 2A-2C, the recess 27 may be structured to receive an insertable attachment component. The recess may have a first protrusion 40 and a second protrusion 41. The first protrusion 40 and/or the second protrusion 41 may engage the insertable attachment component to couple the insertable attachment component and the window jamb. As such, the insertable attachment component (e.g., insertable attachment component 200 of FIG. 2A and the insertable attachment component 205 of FIG. 2B) may be structured with a tooth structure to receive the first protrusion 40 and/or the second protrusion 41.

In various embodiments, the window jambs may include one or more receptor channels (e.g., receptor channel 32, receptor channel 36, receptor channel 38, and/or the like). The lineal profile of the second window jamb 21 of FIG. 1B includes a receptor channel 32 and a co-co-extruded first screw boss 34 in a receptor channel 36. These features, receptor channel 32 and first screw boss 34, facilitate attachment of a panel or other protective exterior covering for protection of glazing held by the frame (e.g., within recess 26 and/or recesses 27), and is co-co-extruded as part of linear profile of the given window jamb. The second end 105 may be flat or have another configuration and may be ornamental as it is the part of window jamb that faces to the exterior.

A screw or other fastener may be driven left to right (as oriented in the FIG. 1B) into the second end 105 of FIG. 1B into receptor channel 32, which serves to guide the screw or other fastener into first screw boss 34, which provides additional holding power against withdrawal of screws used to hold a panel to first window jamb 20. Various embodiments of a window jamb may include any number of screw bosses positioned within receptor channels (e.g., receptor channel 36 and/or receptor channel 38). The first screw boss 34 may be structured to receive a screw to hold on a storm cover. In various embodiments, a window jamb may be structured (e.g., via a screw boss or other attachment means) to allow for a storm cover (e.g., a protective fabric, a wood or otherwise solid panel, and/or the like) to be attached. The storm cover may be attached by screwing one or more screws into the given window jamb. While the term “screw” is used herein, any number of different fasteners may be used herein and the term screw is not meant to be limiting to exclusively screws.

As discussed herein, a screw boss (e.g., the first screw boss 34 shown in FIG. 1B) is a device that may be made separately from window jamb by extrusion, and which a screw boss presents a series of barriers across a long dimension to the advancement of a screw inserted at receptor channel 32 and driven into any one of the window jambs of various embodiments. For example, the tip of a long screw penetrates into first screw boss 34 on insertion into the second window jamb 21. A long screw is more difficult to withdraw from a screw boss, such as first screw boss 34, by pulling than to unscrew it, and thus provides resistance to the removal of the screw by force—and thus resists the wind's effect on a panel or other covering over the window. Plural screws (not shown) along the window frame made using the various window jambs may be used to hold such a panel (not shown) to the exterior of an extruded window frame. The presence of screw bosses in at least two sides of window frame, jambs or sill and header, for example, provide additional security against the force of strong winds pulling on the panel or fabric covering of the frame and subsequently exposing the window glazing to damage.

Thus, when multiple windows of a building may have different levels of window protection and yet look the same from the exterior, flexibility in providing that particular level for the windows can be achieved by the use of inserted screw bosses for specific windows. Some windows do not need impact resistant glass, and some windows do not need co-extruded internal and external screw bosses, so the ability to decide whether to add screw bosses as the windows are built enables considerable flexibility and economy in accommodating the individual needs for window protection.

Also, some components of a frame do not need to contain screw bosses. Inserting screw bosses in headers and sills uses shorter segments of screw bosses then when screw bosses are inserted in the jambs. This is a feature of the present disclosure. In addition to flexibility in choosing whether to insert screw bosses or not in any particular window frame, there is also the flexibility in determining if screw bosses are to be used in the header and sill of a frame rather than in the jambs, or in the jambs and not in the header and the sill.

In addition to windows and other framed openings, doors may also provide protection from damage from severe weather.

FIG. 1C illustrates another example window jamb 22 with a solid-head window frame. As shown, the window jamb 22 may have a closed frame head 56 that causes the recess (recess 27 of FIGS. 1A and 1B) to be enclosed. In such an instance, as shown in FIG. 2D, the insertable attachment component 220 may be exterior to the window frame. While the closed frame head 56 is shown in window jamb 22 that is similar in structure to window jamb 20 of FIG. 1A, a closed window head 56 may be provided on various types of window jambs, such as window jamb 21 shown in FIG. 1B. The window jamb 22 may include an attachment receiver 55 that is provided to receive an attachment component and/or a blind.

Referring now to FIGS. 2A-2D, example insertable attachment components are shown in accordance with various embodiments. The insertable attachment components are shown positioned within the recess 27. As such, the insertable attachment components of FIGS. 2A-2C may be used in any window jamb that includes a recess 27 sized to receive the given insertable attachment component. For example, a insertable attachment component of various embodiments may with either of the window jamb 20 of FIG. 1A, window jamb 21 of FIG. 1B, and/or various other window jambs. The insertable attachment component 220 of FIG. 2D may be used in window jambs with or without the recess 27. In various embodiments, a given window jamb may be structured to couple to one or more of the insertable attachment components shown in FIGS. 2A-2D. For example, any of the insertable attachment components of FIGS. 2A-2D may be used in the window jamb 20.

Referring now to FIG. 2A, a insertable attachment component 200 is shown positioned within the recess 27 of the window jamb 20. In various embodiments, the insertable attachment component 200 may be used with any window jamb that includes a recess 27 sized to receive the insertable attachment component 200. In various embodiments a glazing may also be received by the recess 27 in addition to any of the insertable attachment components discussed herein. Alternatively, a glazing may only be provided within the recess 26.

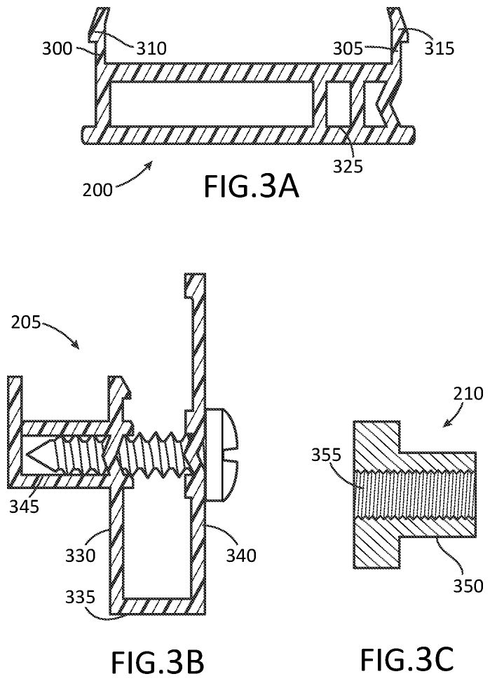

The insertable attachment component 200 is shown in more detail in FIG. 3A. In various embodiments, the insertable attachment component 200 may be coupled to the given window jamb (within the recess 27) at least partially via a snap-fit with the window jamb (e.g., a snap-fit between the insertable attachment component 200 and the first protrusion 40 and/or the second protrusion 41). For example, the insertable attachment component 200 may define at least one cantilever portion with a tapered hook defined to engage with another tapered hook and the window jamb may define at least one tapered hook (e.g., the first protrusion 40 and/or the second protrusion 41).

As shown in FIG. 3A, the insertable attachment component 200 includes a first cantilever portion 300 and a second cantilever portion 305. Each of the first cantilever portion 300 and the second cantilever portion 305 define a protrusion (e.g., a first cantilever portion protrusion 310 of the first cantilever portion 300 and a second cantilever portion protrusion 315 of the second cantilever portion 305). The protrusions (e.g., the first cantilever portion protrusion 310 and the second cantilever portion protrusion 315) may be tapered hook.

In various embodiments, the first cantilever portion protrusion 310 and the second cantilever portion protrusion 315 may be outwardly facing to engage with the first protrusion 40 and the second protrusion 41 of the recess 27. As such, the first cantilever portion protrusion 310 may engage with the first protrusion 40 and the second cantilever portion protrusion 315 may engage with the second protrusion 41, such that the insertable attachment component 200 is coupled to the given window jamb.

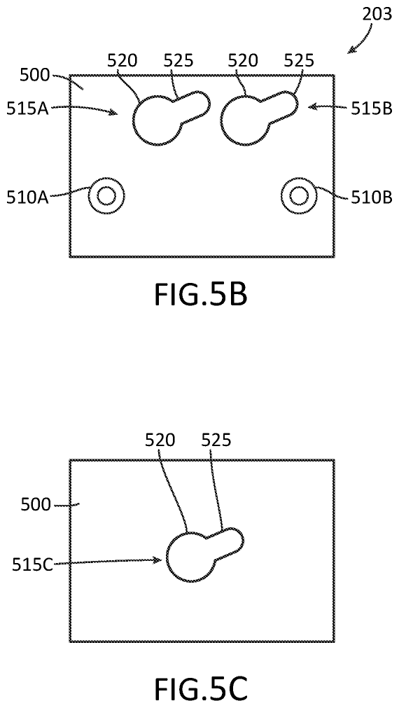

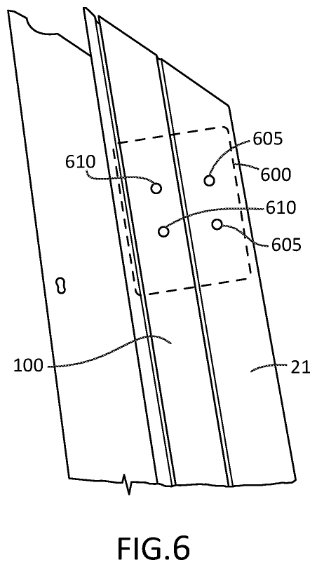

The insertable attachment component 200 defines a screw boss 325. The screw boss 325 is structured to receive a screw 201 (or screws) via the first end 100 of the given window jamb (e.g., window jamb 20). The screw 201 holds the blind bracket 203 in place. While a single screw 201 is shown in FIGS. 2A-2C, any number of screws may be used based on the structure of the blind bracket. For example, in an instance in which blind bracket 203 includes two screw apertures, as shown in FIGS. 5A and 5B, two screws may be used to attach the blind bracket. As such, the screw boss 325 may be capable of receiving multiple screws and/or multiple screw bosses may be defined along the window jamb (e.g., provided along the extruded axis of the lineal profile of the given window jamb). The blind bracket 203 is shown and discussed in more detail below in reference to FIGS. 5A and 5B. As such, the insertable attachment component 200 via the screw boss 325 is structured to hold the blind bracket 203 in place, as discussed herein.

In various embodiments, the blind bracket 203 may be made out of metal, polymeric material, and/or other materials.

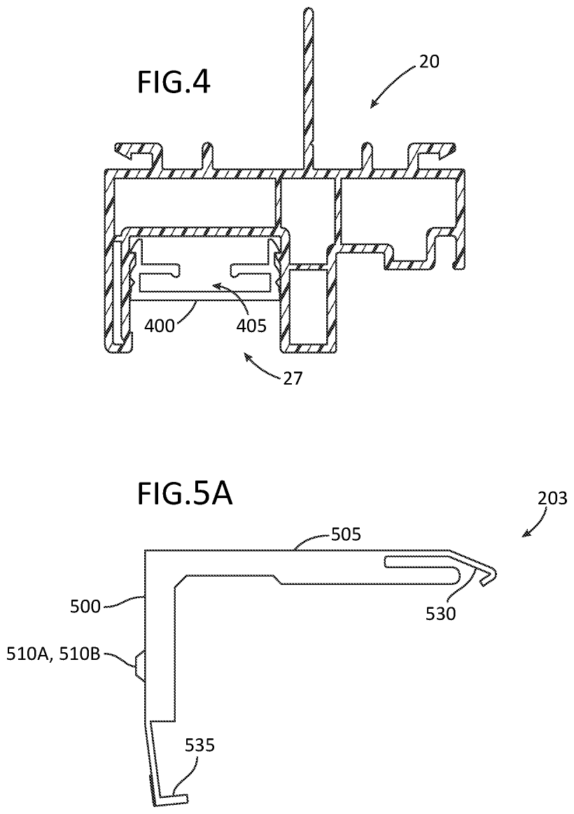

In various embodiments, the screw(s) may be preinstalled into the window jamb. As such, the screws may be less than fully tightened (or may be loosened by a user), such that the blind bracket may be positioned on the screw (e.g., via the screw apertures 515A, 515B shown in FIG. 4). In such an instance, the screw may be structured to be tightened via a short turn. In various embodiments, the screw (and the blind bracket) may be secured by turning the screw less than one full rotation. In various embodiments, the screw (and the blind bracket) may be secured by turning the screw less than three-quarters of a full rotation. In various embodiments, the screw (and the blind bracket) may be secured by turning the screw less than half of a full rotation. In various embodiments, the screw (and the blind bracket) may be secured by turning the screw one quarter of a full rotation.

Referring now to FIG. 2B, another example insertable attachment component 205 is shown positioned on a window jamb (e.g., the window jamb 20). As stated above, the insertable attachment component 205 may be used for various different window jamb lineal profiles and may be sized accordingly. The insertable attachment component 205, shown more clearly in FIG. 3B, comprises a first side 330, a second side 335, and a third side 340. The insertable attachment component 205 defines a generally U-shape that is structured to fit on a protrusion 250 of the given window jamb. As such, a portion of the insertable attachment component 205 is received by the recess 27 and a portion of the insertable attachment component 205 is exterior to the recess 27 (e.g., along the first end 100 of the given window jamb).

In various embodiments, the insertable attachment component 205 may be coupled to the given window jamb (partially with the recess 27) at least partially via a snap-fit with the window jamb (e.g., a snap-fit between the insertable attachment component 205 and the first protrusion 40). For example, the insertable attachment component 205 may define at least one cantilever portion (e.g., the first side 330) with a tapered hook defined to engage with another tapered hook on the window jamb (e.g., the first protrusion 40).

The insertable attachment component 205 defines a screw boss 345. The screw boss 345 is structured to receive a screw 201 via the first end 100 of the window jamb (e.g., window jamb 20). For example, the screw 201 may be inserted into the third side 340 of the insertable attachment component 205, pass through the protrusion 250 of the window jamb, and into the first side 330 of the insertable attachment component 205 (e.g., into the screw boss 345). The screw 201 holds the blind bracket 203 in place relative to the window jamb. While a single screw 201 is shown in FIG. 2B, any number of screws may be used based on the structure of the blind bracket. For example, in an instance in which blind bracket 203 includes two screw apertures, as shown in FIGS. 5A and 5B, two screws may be used to attach the blind bracket. As such, the screw boss 345 may be capable of receiving multiple screws and/or multiple screw bosses may be defined along the window jamb (e.g., provided along the extruded axis of the lineal profile of the given window jamb). The blind bracket 203 is shown and discussed in more detail below in reference to FIGS. 5A and 5B. As such, the insertable attachment component 205 via the screw boss 345 is structured to hold the blind bracket 203 in place, as discussed herein. The first side 330, the second side 335, and the third side 340 of the insertable attachment component 205 may be structured such that the screw, upon being inserted into the window jamb, are coupled to the window jamb.

Referring now to FIG. 2C, still another insertable attachment component is shown in accordance with various embodiments. The insertable attachment component 210 may have been seen in FIG. 3C. The insertable attachment component 210 may be merely a screw boss that is circular, such that a portion of the insertable attachment component 210 may be positioned within an aperture defined in the protrusion 250 of the given window jamb. As shown, the insertable attachment component 210 defines an inner portion 350 and an outer portion 355. The inner portion has a circular cross-section that is slightly smaller than the aperture defined within the protrusion 250 of the window jamb, such that the inner portion 350 may be received herein. The inner portion 350 may have a circular cross-section that is greater than the screw 201, such that the inner portion 350 may define an interior threading to receive the screw. The outer portion 355 defines a cross-sectional area (e.g., circular or otherwise) that is larger than the aperture defined within the protrusion 250, such that upon introducing the screw 201 into the insertable attachment component 210, the insertable attachment component 210 is held in place relative to the window jamb.

While a single screw 201 is shown in FIG. 2C, any number of screws may be used based on the structure of the blind bracket. For example, in an instance in which blind bracket 203 includes two screw apertures, as shown in FIGS. 5A and 5B, two screws may be used to attach the blind bracket by providing two of the insertable attachment component 210 (e.g., provided along the extruded axis of the lineal profile of the given window jamb).

Referring now to FIG. 2D, a insertable attachment component 220 is shown attached to the exterior of the window jamb 22. While the insertable attachment component 220 is shown attached to window jamb 22, the insertable attachment component 220 may be used with various different window jambs with or without the recess 27 (e.g., window jamb 20 of FIG. 1A, window jamb 21 of FIG. 1B). The attachment receiver 55 of window jamb 22 may receive any number of different insertable attachment components, such as insertable attachment component 220. In various embodiments, an insertable attachment component may be unitary or otherwise attached to a blind bracket and/or blind.

As shown in FIG. 2D, the insertable attachment component 220 may include an insertion engagement mechanism 255. The insertion engagement mechanism 255 may engage with the attachment receiver 55 to couple the insertable attachment component 220 to the window jamb 22. As shown, the attachment receiver 55 may include a protrusion that engages a protrusion of the insertion engagement mechanism 255. The coupling of the attachment receiver 55 to the insertable attachment component 220 may be permanent or temporary. For example, the couple may be such that the insertion engagement mechanism 255 may not be removed without causing damage to at least one of the attachment receiver 55 or the insertable attachment component 220. Alternatively, the attachment receiver 55 and the insertable attachment component 220 may be decoupled by applying a force to the attachment receiver 55 and/or the insertable attachment component 220 to disengage the coupling between the attachment receiver 55 and the insertable attachment component 220.

The insertable attachment component 220 shown in FIG. 2D may include a first edge 260, a second edge 265, and a third edge 270. The first edge 260 may be attached to the second edge 265 at a first end of the second edge 265. The third edge 270 may be attached to the second edge at a second end opposite the first end of the second edge 265. In various embodiments, each of the first edge 260, the second edge 265, and/or the third edge 270 may be unitary (e.g., created via bending the insertable attachment component 220 at each end of the second edge 265). As such, the term “attached” may also indicate a unitary piece that is bent into multiple edges, as shown. The attachment and/or bend may be structured such that the first edge and the second edge are generally perpendicular to one another, and the third edge and the second edge are generally perpendicular to one another. The shape of the insertable attachment component 220 may be similar to the first end 100 of the window jamb 22. As shown, upon installation of the insertable attachment component 220, the first end 100 of the window jamb 22 is positioned within the insertable attachment component.

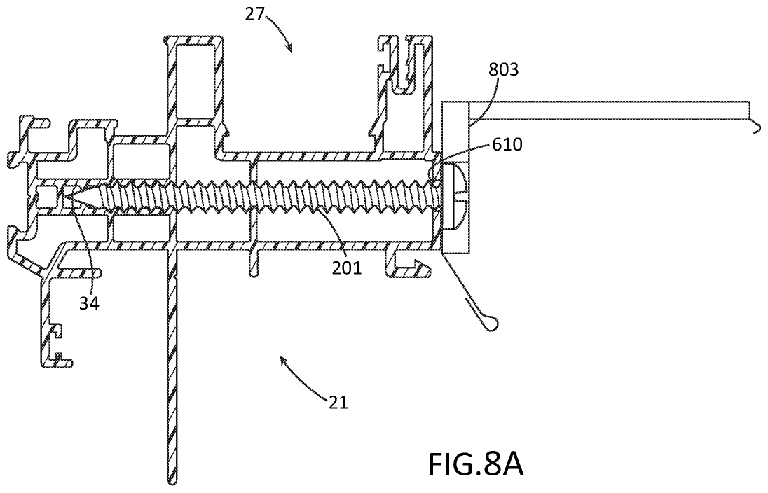

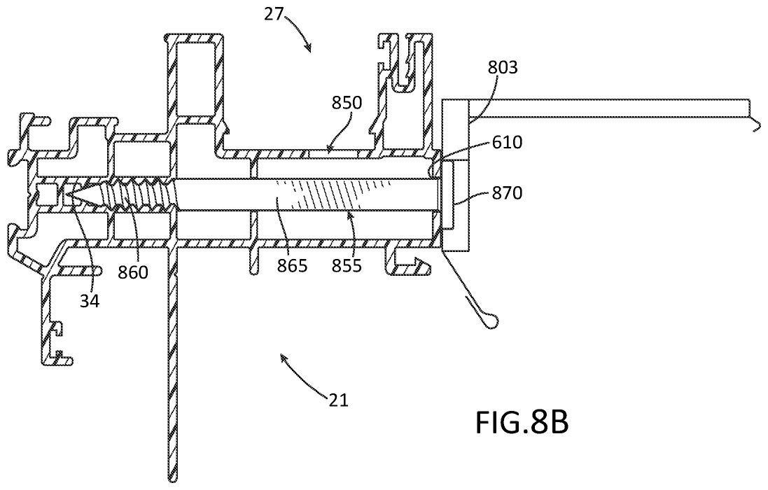

In various embodiments, one or more screw apertures may be defined on the insertable attachment component 220, in the same fashion as the screw apertures defined on the insertable attachment components of FIGS. 2A and 2B. As such, the insertable attachment component may be capable of receiving a screw to fasten a blind bracket to the insertable attachment component 220. In various embodiments, one or more apertures may also be defined within the window jamb to receive the screw inserted through the insertable attachment component 220. For example, the window jamb may define a screw boss, such as the screw boss shown in FIGS. 8A and/or 8B to receive the screw passed through the insertable attachment component 220.

Referring now to FIG. 4, another insertable attachment component 400 is shown that is similar in structure to the insertable attachment component 200. As shown, the insertable attachment component 400 is coupled to the window jamb within the recess 27 via a snap-fit. The insertable attachment component is similar to the insertable attachment component 200 shown in FIGS. 2A and 3A. As such, the insertable attachment component 400 includes two cantilever portions with taper hooks structured to engage with each of the first protrusion 40 and the second protrusion 41 defined within the recess 27. The insertable attachment component 400 also includes a screw boss 405 that is structured to receive a screw.

Referring now to FIGS. 5A and 5B, a side view (FIG. 5A) and a front view (FIG. 5B) of a blind bracket 203 is shown in accordance with various embodiments. The blind bracket 203 includes an attachment side 500 and an extending side 505. The attachment side 500 of the blind bracket 203 is structured to attach the blind bracket 203 to the window jamb (e.g., window jamb 20, window jamb 21, etc.). Upon placement, the attachment side 500 is structured to be adjacent to the first end 100 of the window jamb. The attachment side 500 is generally perpendicular to the extending side 505.

The attachment side 500 is shown in FIG. 5B. As shown, the attachment side 500 may include one or more protruding dimples (e.g., protruding dimples 510A, 510B). The protruding dimples are structured to engage with inward dimples defined on the protrusion 250 of the window jamb. The protruding dimples 510A, 510B are structured to assist placement of the blind bracket 203 (e.g., a user knows that the blind bracket 203 is correctly positioned upon engagement between each of the protruding dimples and the given inward dimples of the window jamb). Any number of protruding dimples may be used. For example, two protruding dimples 510A, 510B may be used. The protruding dimples 510A, 510B also limit movement of the blind bracket 203 under load (e.g., with a blind installed).

The attachment side 500 also includes one or more screw apertures 515A, 515B, which are structured to receive a screw (e.g., screw 201) that attaches the blind bracket to the window jamb. In various embodiments, the blind bracket 203 of FIGS. 5A and 5B may be attached to any structure (e.g., window jamb, door, wall, etc.) and are not limited to the attachment methods of FIGS. 2A-2C. In various embodiments, the attachment side 500 may define any number of screw apertures. A screw 201 is passed through a screw aperture and tightened in order to fix the blind bracket 203 relative to a structure (e.g., relative to the window jamb).

The screw apertures 515A, 515B may each have a receiving portion 520 and a tightening portion 525. The receiving portion 520 of the given screw aperture is define with a larger cross-sectional area than a head of the screw used to attach the blind bracket 203 to a structure. As such, the screw head may pass through the receiving portion 520. In various embodiments, the screw 201 may be pre-inserted into a structure, such as the window jamb, and left less than fully tightened in order to receive the blind bracket 203. In such an embodiment, the blind bracket 203 is positioned by placing the head of the screw through the receiving portion 520 of the screw aperture.

In various embodiments, the screw aperture is slotted such that the body of the screw may move along the screw aperture into the tightening portion 525. The tightening portion 525 defines a width less than the diameter of the head of the screw and more than the diameter of the body of the screw, such that the screw may move along the screw aperture, but cannot be removed in an instance in which at least a portion of the screw is in the tightening portion 525. Upon movement to the tightening portion 525, the screw may be completed tightened, fixing the blind bracket 203 to the structure. This operation may be completed for each screw aperture until each screw is tightened and the blind bracket 203 is fixed relative to the structure (e.g., the window jamb). In various embodiments, the screw(s) 201 may be preinstalled into a window jamb (e.g., less than fully tight to allow the blind bracket to be positioned), such that the blind bracket 203 may be positioned and then fixed via the screws.

The extending side 505 extends laterally from the attachment side 500 and extends upon placement laterally from the structure (e.g., the window jamb). The attachment side 500 and/or the extending side 505 may include a coupling mechanism (e.g., tab 530 and/or tab 535) that engage with a blind to couple the blind to the blind bracket 203. As such, a blind may be placed within the blind bracket 203, such that tab 530 and/or tab 535 may engage with a top rail of the blind to fix the top rail of the blind to the window jamb. Additionally or alternatively, a blind bracket 203 (or any blind bracket) may be defined along a bottom edge of the window frame to receive a bottom rail of the blind.

FIG. 5C illustrates a blind bracket 203 with another example attachment side 500 with a singular screw aperture 515C. As shown, the attachment side 500 may include a screw aperture 515C that include a receiving portion 520 and a tightening portion 525. The screw aperture 515C may be generally larger than screw apertures 515A and 515B of FIG. 5B to facilitate a larger screw. Alternatively, the screw aperture 515C may be similar in size to the screw apertures 515A and 515B of FIG. 5B. In an example embodiment, only a singular screw may be required to affix the blind bracket 203 to the given window jamb. Example screws used include the screw 201 and/or screw 855 shown in FIGS. 8A and 8B. In various embodiments, the attachment side 500 shown in FIG. 5C may also have one or more protruding dimples 510A, 510B shown in FIG. 5B. in various embodiments, the components of FIGS. 5B and 5C may be interchanged based on the design of the window jamb.

Referring now to FIG. 6, example aperture locations are shown along a first end 100 of a window jamb (e.g., a window jamb 21). As shown, the apertures in the window jamb may be defined proximate an end of the window jamb. For example, a window frame may include a top window jamb, two side window jambs, and a bottom window jamb, which together form the window frame. As such, the apertures to receive a blind bracket may be positioned proximate an end of one of the window jambs (e.g., the top window jamb and/or the bottom window jamb), such as area 600 shown in FIG. 6. As discussed herein, any number of screws may be used for a blind bracket and the number of apertures on the window jamb may be based on the number of screws used for a bracket. In various embodiments, the window jamb may have predrilled apertures. The predrilled apertures may be positioned to engage with one or more blind brackets. For example, a window jamb may have multiple apertures that allow for different screw patterns on different blind brackets to be used.

FIG. 6 illustrates four example apertures (e.g., lower aperture(s) 605 and upper aperture(s) 610). Each of the apertures are structured to receive a screw (e.g., screw 201). A window jamb of various embodiments may have any number of apertures (lower aperture(s) 605 and/or upper aperture(s)). For example, a window jamb may have only one or more lower apertures 605, only one or more upper apertures 610, or at least one of one or more lower apertures 605 and one or more upper apertures 610. As shown in FIG. 6, the number of lower aperture(s) 605 and upper aperture(s) 610 may be equal (e.g., both have two apertures). Alternatively, the number of lower aperture(s) 605 and upper aperture(s) 610 may be different (e.g., based on the design of a blind bracket). In various embodiments, aperture(s) (e.g., lower aperture(s) 605 and/or upper aperture(s) 610) may be defined proximate an end of the window jamb. For example, the blind brackets may be positioned outside the edges of the windows, such that the blind covers the window during use. As such, the apertures may be defined outside the outer edges of the window. As such, the distance between the given apertures (and the corresponding insertable attachment components) may be based on the size of the window (e.g., the width of the window).

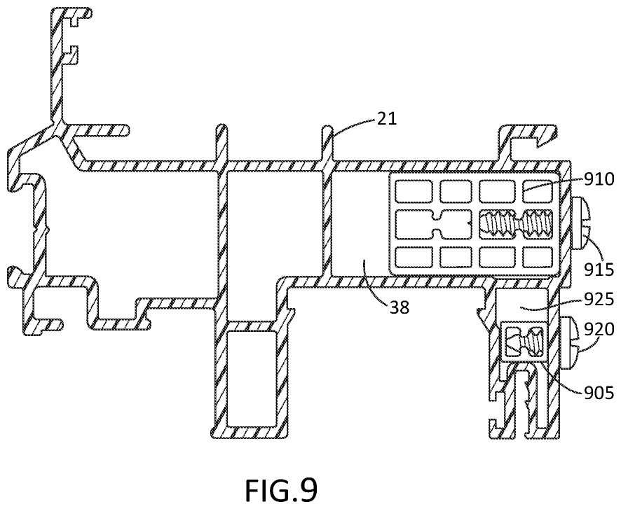

In various embodiments, the lower aperture(s) 605 are provided to receive a screw. The screw may pass through the given lower aperture and into the insertable attachment component (e.g., any of the insertable attachment components of FIGS. 2A-2C). As discussed above, in an instance multiple lower apertures 605 are provided, the insertable attachment component may be capable of receiving multiple screws (e.g., via an elongated screw boss) and/or additional insertable attachment components may be provided along recess 27. In various embodiments, such as shown in FIG. 9, a screw boss may be provided outside of the recess 27 and use the lower aperture(s) 605 to receive the screw.

In various embodiments, the upper aperture(s) 610 may be provided to allow a screw to pass through and into the screw boss 34 (shown in FIG. 1A). The screw used in the upper aperture(s) 610 may be longer than a screw used in the lower aperture(s) 605. In various embodiments, the screws used in the lower aperture(s) 605 and/or the upper apertures 610 may be preinstalled before a blind bracket is installed. For example, the screw may be screwed into a loose position that allows the blind bracket to be positioned relative to the window jamb as discussed herein.

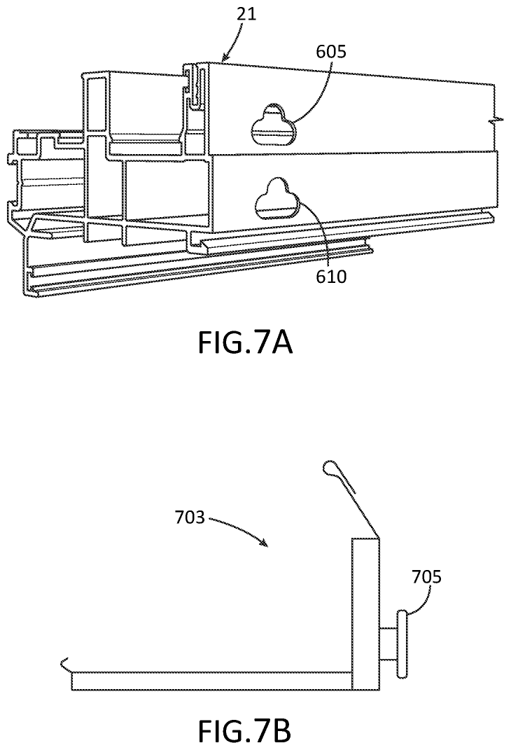

Referring now to FIGS. 7A and 7B, an additional configuration for apertures within the window jamb (FIG. 7A) is provided and additional example blind bracket (FIG. 7B) for such a configuration is shown. As shown, the lower aperture(s) 605 and/or the upper aperture(s) 610 of a window jamb (e.g., window jamb 21) may have a keyhole slot shape, such that an engagement protrusion 705 (such as a mushroom bolt or the like) may be received by a portion of the given aperture and slide along the aperture into a locked position.

The blind bracket 703 is shown with a single engagement protrusion 705. However, any number of engagement protrusion may be provided on the blind bracket 703. For example, the blind bracket 703 may have an engagement protrusion 705 for one or more of the apertures (e.g., lower aperture(s) 605 and/or upper apertures 610) defined on the window jamb. In various embodiments, the blind bracket may include screw apertures, as discussed above in reference to blind bracket 203, in addition to one or more engagement protrusions 705. Additionally, any of the blind brackets discussed herein (e.g., blind bracket 203, blind bracket 703, blind bracket 803, etc.) may include the features of other blind brackets discussed herein. As shown in FIG. 7B, the engagement protrusion 705 may be placed within the lower aperture 605 or the upper aperture 610 shown in FIG. 7A. In various embodiments, an additional engagement protrusion 705 may be provided such that a first engagement protrusion is placed within the lower aperture 605 and a second engagement protrusion is placed within the upper aperture 610.

Referring now to FIGS. 8A and 8B, a blind bracket 803 is shown attached to the window jamb (e.g., window jamb 21 using the screw boss 34. As shown, the blind bracket 803 is attached via a fastener (e.g., screw 201 in FIG. 8A and screw 855 in FIG. 8B) that passed through the blind bracket 803 into the first end 100 of the window jamb via an upper aperture 610 and into the screw boss 34. In such an instance, an insertable attachment component may not be used (e.g., allowing the recess 27 to be used to receive a glazing (e.g., window glass) and/or other functions)). In various embodiments, an insertable attachment component (e.g., any of the insertable attachment components of FIGS. 2A-2C) may be used in addition to the screw boss 34. For example, the blind bracket may be attached to the window jamb by at least one screw attached via the upper apertures 610 (e.g., into the screw boss 34) and at least one screw attached via the lower apertures 605 (e.g., into the insertable attachment component).

As shown in FIG. 8B, the screw 855 may include a threaded portion 860 and a non-threaded portion 865. At least a portion of the non-threaded portion 865 may have a square cross-section, such that that a wrench may be inserted into the window jamb via the slot 850. Upon insertion of the wrench into the slot 850, the screw 855 may be tightened and/or loosened by turning the wrench (e.g., the wrench engages the square cross-section of the non-threaded portion 865 of the screw 855). As such, the screw 855 may be preinstalled in the window jamb, such that an installer of a window blind may merely tighten the screw 855 via the slot 850 upon placement of the blind bracket 803 (or other blind brackets discussed herein).

In various embodiments, the head 870 of the screw 855 may include a drive (e.g., a Phillips head, hex head, flat head, etc.) provided on the head to loosen and/or tighten the screw 855. In such an embodiment, the screw 855 may be adjusted via the drive on the head 870 and/or via the slot 850. Alternatively, the head 870 may not have a drive, such that the screw 855 may only be tightened and/or loosened via the slot 850.

Referring now to FIG. 9, another example window jamb configuration is shown. In such an embodiment, a screw boss 910 is defined within receiving channel 38 and a screw boss 905 is defined within receiving channel 925. In the example shown in FIG. 9, a screw 915 may be inserted into the screw boss 910 and a screw 920 may be inserted into the screw boss 905. The length and dimensions of the screws may be based on the position and size of the given screw boss. For example, the screw boss 910 is longer than the screw boss 905, and as such the screw 915 used with the screw boss 910 is longer than the screw 920 that is used with the screw boss 905.

Unless stated otherwise, any of the configurations of various embodiments may be used interchangeably. For example, a screw boss 910 may be located in receiving channel 38 to receive one or more screws with an insertable attachment component inserted into the recess 27 to receive one or more screws. As such, none of the embodiments are exclusory unless specifically stated.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A window jamb assembly, comprising:
a window jamb with a recess along a lineal profile of the window jamb, wherein at least one protrusion is defined within the recess; and
an insertable attachment component comprising a screw boss, wherein the insertable attachment component is structured to engage with the at least one protrusion defined within the recess,
wherein the insertable attachment component is structured to receive a screw via the screw boss.

2. The window jamb assembly of claim 1, further comprising a blind bracket, wherein the blind bracket defines at least one screw aperture that allows the screw to pass through and engaged the screw boss of the insertable attachment component.

3. The window jamb assembly of claim 2, wherein the blind bracket defines an attachment side, wherein the attachment side comprises the at least one screw aperture and at least one protruding dimple.

4. The window jamb assembly of claim 3, wherein the window jamb comprises an inward dimple structured to receive the at least one protruding dimple.

5. The window jamb assembly of claim 2, wherein the blind bracket defines an attachment side and an extending side, wherein the extending side is perpendicular to the attachment side.

6. The window jamb assembly of claim 5, wherein at least one of the attachment side or the extending side define a tab that is structured to engage a blind.

7. The window jamb assembly of claim 1, further comprising an additional insertable attachment component comprising an additional screw boss, wherein the additional insertable attachment component is structured to engage with the at least one protrusion defined within the recess.

8. The window jamb assembly of claim 7, wherein the insertable attachment component is inserted proximate a first end of the window jamb and the additional insertable attachment component is inserted proximate a second end of the window jamb.

9. The window jamb assembly of claim 8, wherein a distance between the insertable attachment component and the additional insertable attachment component is based on a size of a window.

10. The window jamb assembly of claim 1, wherein the insertable attachment component defines at least one cantilever portion structured to engage at least one of the at least one protrusion defined within the recess.

11. The window jamb assembly of claim 10, wherein the at least one cantilever portion comprises a tapered hook to engage at least one of the at least one protrusion defined within the recess.

12. The window jamb assembly of claim 1, wherein the insertable attachment component comprises a U-shape with a first side, a second side, and a third side, wherein the first side of the insertable attachment component is engageable with one of the at least one protrusion.

13. The window jamb assembly of claim 1, wherein the window jamb defines a first end and a second end, wherein the first end of the window jamb comprises an aperture to receive a screw.

14. A method for manufacturing a window jamb assembly, the method comprising:
providing a window jamb with a recess along a lineal profile of the window jamb, wherein at least one protrusion is defined within the recess; and
providing an insertable attachment component comprising a screw boss, wherein the insertable attachment component is structured to engage with the at least one protrusion defined within the recess,
wherein the insertable attachment component is structured to receive a screw via the screw boss.

15. The method of claim 14, further comprising providing a blind bracket, wherein the blind bracket defines at least one screw aperture that allows the screw to pass through and engaged the screw boss of the insertable attachment component.

16. The method of claim 15, wherein the blind bracket defines an attachment side, wherein the attachment side comprises the at least one screw aperture and at least one protruding dimple.

17. The method of claim 15, wherein the blind bracket defines an attachment side and an extending side, wherein the extending side is perpendicular to the attachment side, wherein at least one of the attachment side or the extending side define a tab that is structured to engage a blind.

18. The method of claim 14, wherein the insertable attachment component defines at least one cantilever portion structured to engage at least one of the at least one protrusion defined within the recess.

19. The method of claim 18, wherein the at least one cantilever portion comprises a tapered hook to engage at least one of the at least one protrusion defined within the recess.

20. The method of claim 14, wherein the insertable attachment component comprises a U-shape with a first side, a second side, and a third side, wherein the first side of the insertable attachment component is engageable with one of the at least one protrusion.
